(19) United States
(12) Patent Application Publication
(10) Pub. No.: US 2023/0103454 A1
(43) Pub. Date: Apr. 6, 2023

(54) TRANSFER DEVICE AND IMAGE FORMING APPARATUS

(71) Applicants: Hiroshi Kikuchi, Kanagawa (JP); Seiichi Kogure, Kanagawa (JP); Hideki Kimura, Kanagawa (JP); Yutaka Takahashi, Kanagawa (JP); Kazuhiro Shimada, Kanagawa (JP); Yusuke Ishizuka, Kanagawa (JP); Takuya Akiyama, Kanagawa (JP); Yutaka Goto, Kanagawa (JP); Yuuki Aoki, Tokyo (JP)

(72) Inventors: Hiroshi Kikuchi, Kanagawa (JP); Seiichi Kogure, Kanagawa (JP); Hideki Kimura, Kanagawa (JP); Yutaka Takahashi, Kanagawa (JP); Kazuhiro Shimada, Kanagawa (JP); Yusuke Ishizuka, Kanagawa (JP); Takuya Akiyama, Kanagawa (JP); Yutaka Goto, Kanagawa (JP); Yuuki Aoki, Tokyo (JP)

(73) Assignee: Ricoh Company, Ltd., Tokyo (JP)

(21) Appl. No.: 17/823,605

(22) Filed: Aug. 31, 2022

(30) Foreign Application Priority Data
Oct. 6, 2021 (JP) 2021-164881

(51) Int. Cl. G03G 15/16

(52) U.S. Cl. CPC G03G 15/162; G03G 15/1675; G03G 2215/1623

(57) ABSTRACT

A transfer device includes a transfer roller and a transfer counter roller. The transfer roller has an elastic layer, contacts with and separates from an image bearer including a belt-shaped elastic body, and nips a recording medium with the image bearer. The transfer counter roller has an elastic layer, is disposed facing the transfer roller, and nips the image bearer with the transfer roller. The transfer counter roller or the transfer roller is applied with a bias to transfer the toner image. Each of the elastic layers of the transfer roller and the transfer counter roller has an Asker C hardness of 75 or less. A difference in thickness between the elastic layers of the transfer roller and the transfer counter roller is ±3% or less.

### CROSS-REFERENCE TO RELATED APPLICATION

This patent application is based on and claims priority pursuant to 35 U.S.C. § 119(a) to Japanese Patent Application No. 2021-164881, filed on Oct. 6, 2021, in the Japan Patent Office, the entire disclosure of which is hereby incorporated by reference herein.

### BACKGROUND

### Technical Field

Embodiments of this disclosure relate to a transfer device and an image forming apparatus.

### Related Art

A quadruple-tandem-type color image forming apparatus is known in which four photoconductor drums as image bearers corresponding to four colors of cyan (C), magenta (M), yellow (Y), and black (K) are arranged side by side such that outer circumferential surfaces of the photoconductor drums are positioned on the same plane.

In this image forming apparatus, for example, toner images of respective colors formed on the outer circumferential surfaces of respective photoconductor drums by developing units are superimposed and transferred onto an intermediate transfer belt as an image bearer by primary transferors disposed corresponding to the respective photoconductor drums.

In the above-described image forming apparatus, the surface speed (moving speed) of the intermediate transfer belt and the surface speed (moving speed) of the recording medium are preferably matched when the toner image on the intermediate transfer belt is secondarily transferred to the recording medium by secondary transferor.

### SUMMARY

In an embodiment of the present disclosure, there is provided a transfer device that includes a transfer roller and a transfer counter roller. The transfer roller has an elastic layer on an outer surface of the transfer roller, contacts with and separates from an image bearer including a belt-shaped elastic body to bear a toner image, and nips a recording medium between the image bearer and the transfer roller. The transfer counter roller has an elastic layer on an outer surface of the transfer counter roller, is disposed facing the transfer roller via the image bearer, and nips the image bearer with the transfer roller. The transfer counter roller or the transfer roller is configured to be applied with a bias to transfer the toner image on the image bearer onto the recording medium. Each of the elastic layer of the transfer roller and the elastic layer of the transfer counter roller has an Asker C hardness of 75 or less. A difference in thickness between the elastic layer of the transfer roller and the elastic layer of the transfer counter roller is ±3% or less.

In another embodiment of the present disclosure, there is provided an image forming apparatus that includes the transfer device and the image bearer.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 is a front view of an image forming apparatus according to an embodiment of the present disclosure;

FIG. 2 is a diagram illustrating a behavior of a recording medium in a comparative secondary transfer unit;

FIG. 3 is a graph illustrating a relationship between the rigidity (sheet thickness) of a recording medium and the image magnification error variation of the comparative secondary transfer unit;

FIG. 4 is a diagram illustrating a behavior of a recording medium in a secondary transfer unit according to an embodiment of the present disclosure; and

FIG. 5 is a graph illustrating a relationship between the rigidity (sheet thickness) of a recording medium and the image magnification error variation of a secondary transfer unit according to an embodiment of the present disclosure.

The accompanying drawings are intended to depict embodiments of the present invention and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

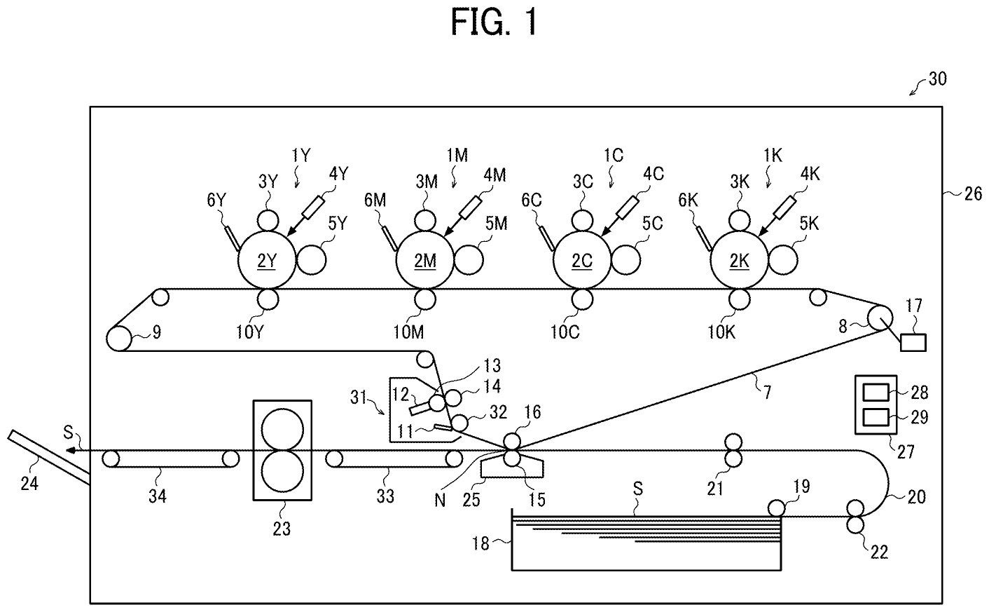

FIG. 1 illustrates a printer 30 as an image forming apparatus according to an embodiment of the present disclosure. The printer 30 functions as an image bearer to bear a toner image to be transferred to a transfer sheet S as a recording medium and includes a movable intermediate transfer belt 7 as an intermediate transferor in a substantially central portion of an apparatus body 26. The printer 30 is a quadruple tandem-type color image forming apparatus in which four image forming units 1Y, 1M, 1C, and 1K are arranged along a traveling direction of the intermediate transfer belt 7. In the drawings and following descriptions, suffixes Y, M, C, and K of reference numerals indicate members corresponding to colors of yellow, magenta, cyan, and black, respectively. The image forming units 1Y, 1M, 1C, and 1K have substantially the same configuration except for toner colors thereof. In the following description, a controller 27 that performs various controls of the printer 30 is disposed in the apparatus body 26 of the printer 30. The controller 27 has a central processing unit (CPU) 28 that is a central processing unit and a memory 29 including, for example, a read only memory (ROM) and a random access memory (RAM).

An image forming unit 1 includes a photoconductor 2 that functions as an image bearer and further includes, for example, a photoconductor cleaning blade 6, a charging device 3, an exposure device 4, and a developing device 5 around the photoconductor 2. During full-color image formation, the printer 30 forms visible images on the respective photoconductors 2 in the order of the image forming unit 1Y for yellow, the image forming unit 1M for magenta, the image forming unit 1C for cyan, and the image forming unit 1K for black. The visible images of the four colors formed on the respective photoconductors 2 are superimposed and transferred onto the intermediate transfer belt 7 to form a full-color toner image on the intermediate transfer belt 7.

The intermediate transfer belt 7 made of an elastic body is stretched over a plurality of rollers such as a drive roller 8, a tension roller 9, and a secondary transfer counter roller 16. An intermediate transfer drive motor 17 drives the drive roller 8 to rotate. Thus, the intermediate transfer belt 7 is driven to travel in a clockwise direction in FIG. 1. A pair of intermediate-transfer-belt-unit side plates rotatably support rollers supporting the intermediate transfer belt 7 and are disposed at both ends of the intermediate transfer belt 7 in a width direction that is a direction perpendicular to the sheet surface on which FIG. 1 is drawn. Four primary transfer rollers 10Y, 10M, 10C, and 10K and a brush counter roller 14 are disposed inside a loop of the intermediate transfer belt 7. In a state in which the outer circumferential surface of each of the primary transfer rollers 10 and the brush counter roller 14 contacts the inner circumferential surface of the intermediate transfer belt 7, a support shaft of each of the primary transfer rollers 10 and the brush counter roller 14 is rotatably supported by the intermediate transfer belt unit side plates via, for example, bearings and arms. Each of the primary transfer rollers 10 and the brush counter roller 14 is driven to rotate with the traveling movement of the intermediate transfer belt 7.

Each primary transfer roller 10 is disposed at a contact portion between each photoconductor 2 and the intermediate transfer belt 7. A predetermined transfer bias is applied to each primary transfer roller 10. Among the primary transfer rollers 10, each of the primary transfer rollers 10Y, 10M, and 10C for color is supported by a corresponding primary-transfer-contact-and-separation mechanism and is contacted with and separated from the intermediate transfer belt 7 by an operation of the primary-transfer-contact-and-separation mechanism. The primary transfer roller 10K for black constantly contacts the intermediate transfer belt 7. With this configuration, in a monochrome mode in which image formation is performed using only the black toner, the image formation is performed by contacting only the primary transfer roller 10K with the intermediate transfer belt 7 and separating the other primary transfer rollers 10Y, 10M, and 10C from the intermediate transfer belt 7. In a full-color mode, the image formation is performed by contacting all the primary transfer rollers 10 with the intermediate transfer belt 7.

An intermediate transfer belt cleaner 31 that cleans an outer circumferential surface of the intermediate transfer belt 7 is disposed in the vicinity of the outer circumferential surface of the intermediate transfer belt 7. The intermediate transfer belt cleaner 31 includes, for example, the brush counter roller 14, a blade counter roller 32, a belt cleaning blade 11, a solid lubricant 12, and a brush roller 13. The intermediate transfer belt 7 is stretched over the blade counter roller 32. Thus, the blade counter roller 32 is driven to rotate with the traveling movement of the intermediate transfer belt 7. The belt cleaning blade 11 made of urethane rubber is contacted and pressed against the blade counter roller 32 via the intermediate transfer belt 7 and blocks and cleans foreign substance such as the toner adhering to the intermediate transfer belt 7. The brush roller 13 is disposed in contact with the brush counter roller 14 via the intermediate transfer belt 7. Thus, the solid lubricant 12 is contacted and pressed against the brush roller 13. With this configuration, an appropriate amount of lubricant scraped off from the solid lubricant 12 by a rotation of the brush roller 13 is uniformly applied to the outer circumferential surface of the intermediate transfer belt 7 to reduce adhesion of the foreign substance.

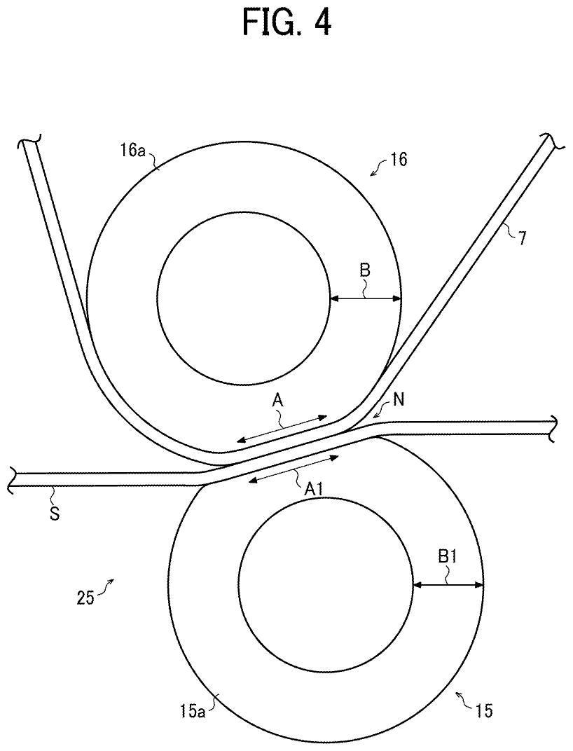

A secondary transfer unit 25 as a transfer device is disposed below the center of the intermediate transfer belt 7. The secondary transfer unit 25 includes a secondary transfer roller 15 and the secondary transfer counter roller 16. The secondary transfer roller 15 has an elastic layer 15a (see FIG. 4) on the outer circumferential surface thereof, and the secondary transfer counter roller 16 has an elastic layer 16a (see FIG. 4) on the outer circumferential surface thereof. Each of the elastic layers 15a and 16a has an Asker C hardness of 75 or less on each outer circumferential surface thereof. The intermediate transfer belt 7 is stretched over the secondary transfer counter roller 16 as a transfer counter roller. The secondary transfer roller 15 as a transfer roller is pressed against and separated from the secondary transfer counter roller 16 via the intermediate transfer belt 7. The secondary transfer counter roller 16 is driven to rotate with the traveling movement of the intermediate transfer belt 7. Thus, the secondary transfer roller 15 is driven to rotate by a roller driver. The secondary transfer roller 15 and the secondary transfer counter roller 16 face each other via the intermediate transfer belt 7 at a secondary transfer portion N. The secondary transfer roller 15 is electrically grounded, and a secondary transfer bias is applied from a secondary transfer bias power source to the secondary transfer counter roller 16, at the secondary transfer portion N. With this configuration, a secondary transfer electric field is generated to electrostatically move the toner on the intermediate transfer belt 7 from the secondary transfer counter roller 16 toward the secondary transfer roller 15.

A sheet storage (sheet tray) 18 that stores transfer sheets S is disposed in a lower portion of the apparatus body 26 located below the secondary transfer unit 25. Although only one sheet storage 18 is disposed in the present embodiment, two or more sheet storages may be disposed. A feed roller 19 that feeds the uppermost sheet of the transfer sheets S stored in the sheet storage 18 to a feed conveyance passage 20 is disposed above the sheet storage 18. The transfer sheet S fed to the feed conveyance passage 20 by the feed roller 19 is conveyed toward the secondary transfer portion N by a conveying roller pair 22 disposed in the feed conveyance passage 20. Thus, the transfer sheet S is temporarily stopped by a registration roller pair 21 disposed downstream from the conveying roller pair 22 in a sheet conveyance direction. The registration roller pair 21 feeds the temporarily stopped transfer sheet S toward the secondary transfer portion N when the toner image formed on the intermediate transfer belt 7 has reached the secondary transfer portion N. The transfer sheet S fed by the registration roller pair 21 is conveyed by a conveyor 33 toward a fixing device 23 disposed downstream from the secondary transfer unit 25 in the sheet conveyance direction after the toner image is transferred from the intermediate transfer belt 7 onto the transfer sheet S at the secondary transfer portion N. The transfer sheet S on which the toner image is fixed by heat and pressure in the fixing device 23 is conveyed further downstream from the fixing device 23 by a conveyor 34. Thus, the transfer sheets S is ejected and stacked on an output tray 24.

In the above-described printer 30, a moving speed of the toner image formed on the intermediate transfer belt 7 and a moving speed of the transfer sheet S are preferably matched when the secondary transfer in which the toner image formed on the intermediate transfer belt 7 is transferred to the transfer sheet S is performed. In other words, a moving speed of a surface of the intermediate transfer belt 7 and a moving speed of a surface of the transfer sheet S are preferably matched. When a speed difference occurs between above-described moving speeds, the image magnification error variation described in the section of “Background Art” occurs at the time of the secondary transfer. For example, when the moving speed of the surface of the transfer sheet S is faster than the moving speed of the surface the intermediate transfer belt 7, a movement amount of the transfer sheet S per unit time is longer than a movement amount of the intermediate transfer belt 7 per unit time. For this reason, a size of the image formed on the transfer sheet S is larger than a size of the ideal image on the data. Thus, the image magnification error variation occurs.

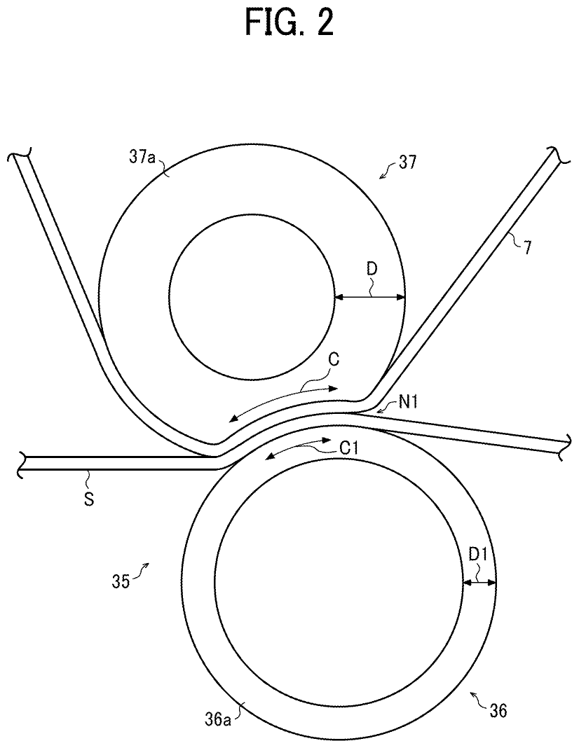

FIG. 2 is a view of a comparative secondary transfer unit. In FIG. 2, a secondary transfer unit 35 includes a secondary transfer roller 36 and a secondary transfer counter roller 37. The secondary transfer counter roller 37 has an elastic layer 37a having an Asker C hardness of 75 or less on an outer circumferential surface thereof and stretches the intermediate transfer belt 7 in the same manner as the secondary transfer counter roller 16. Thus, the secondary transfer counter roller 37 is driven to rotate with the traveling movement of the intermediate transfer belt 7. The secondary transfer roller 36 has an elastic layer 36a having an Asker C hardness of 75 or less on an outer circumferential surface thereof and is driven to rotate by a roller driver. Thus, the secondary transfer roller 36 is pressed against and separated from the secondary transfer counter roller 37 via the intermediate transfer belt 7. A secondary transfer portion N1 in which a toner image on the intermediate transfer belt 7 is secondarily transferred onto a transfer sheet S is formed at an opposing portion between the secondary transfer roller 36 and the secondary transfer counter roller 37.

When the transfer sheet S passes through a nip portion between the secondary transfer roller 36 and the secondary transfer counter roller 37 formed at the secondary transfer portion N1, the image magnification error variation occurs if the nip portion is formed in a curved surface as illustrated in FIG. 2. Specifically, a convex surface (e.g., an upper surface in FIG. 2) of the transfer sheet S is longer (as indicated by a double-headed arrow C) than the central portion of the thickness of the transfer sheet S. A concave surface (a lower surface in FIG. 2) of the transfer sheet S is shorter (as indicated by a double-headed arrow C1) than the central portion of the thickness of the transfer sheet S. The ratio of the difference in length changes according to the rigidity and thickness of the transfer sheet S. The image magnification error variation occurs due to a difference in surface speed based on a difference in length between the upper surface and the lower surface. The comparative secondary transfer unit 35 includes the secondary transfer roller 36 and the secondary transfer counter roller 37 formed of so-called soft rollers having an Asker C hardness of 75 or less to reduce the above-described image magnification error variation. As a result, the nip portion in the secondary transfer portion N1 is flattened as much as possible, and the transfer sheet S is prevented from being curved as much as possible in the nip portion, to reduce the occurrence of the image magnification error variation due to the difference in surface length between the upper surface and the lower surface that occurs when the transfer sheet S is curved.

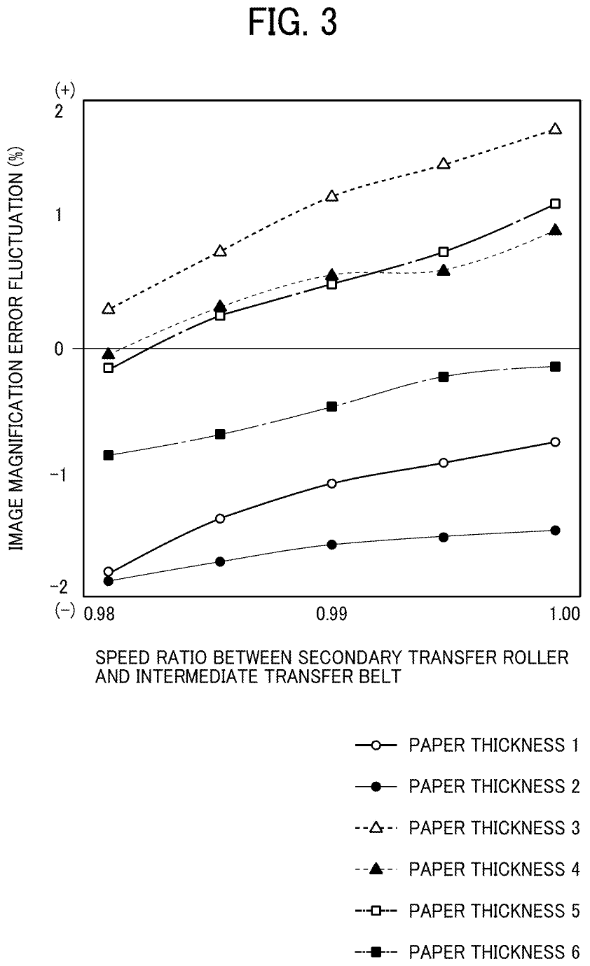

However, as illustrated in FIG. 2, when a large difference occurs between the thickness D1 of the elastic layer 36a of the secondary transfer roller 36 and the thickness D of the elastic layer 37a of the secondary transfer counter roller 37, a difference in deformation amount occurs between the elastic layers 36a and 37a due to the difference in the thickness even if the elastic layers 36a and 37a have substantially the same hardness each other. Deformation occurs in the nip portions of the secondary transfer roller 36 and the secondary transfer counter roller 37 in the secondary transfer portion N1 based on the difference in the deformation amount. The transfer sheet S is curved due to the deformation. Thus, the image magnification error variation occurs due to the difference in surface length between the upper surface and the lower surface. FIG. 3 is a graph illustrating the relationship between rigidity (sheet thickness) of the transfer sheet S and the image magnification error variation in the secondary transfer unit 35. As illustrated in FIG. 3, in the comparative configuration, the variation width of the range of occurrence of the image magnification error variation that occurs due to a difference in rigidity of the transfer sheet S is large on the plus side and the minus side. Thus, reducing (controlling) the image magnification error variation is difficult.

FIG. 4 illustrates a secondary transfer unit 25 according to an embodiment of the present disclosure, to solve the above-described failure of the comparative secondary transfer unit 35. In the secondary transfer unit 25, the thickness of each of the elastic layers 15a and 16a is adjusted so that a length of an upper surface of a transfer sheet S indicated by a double-headed arrow A in FIG. 4 is equal to a length of a back surface of the transfer sheet S indicated by a double-headed arrow A1 to solve the above-described failure. In order to perform this adjustment, the inventors of the present disclosure have determined whether the image magnification error variation has occurred by changing the thicknesses B1 and B of the elastic layers 15a and 16a, respectively, forming images, measuring the image lengths of output materials on which the images were formed, and obtaining the differences from the ideal image lengths on the data. As a result of the determination, when the difference between the thickness B1 of the elastic layer 15a and the thickness B of the elastic layer 16a was ±3% or less, substantially no image magnification error variation occurred. Thus, the output material that can withstand actual use was obtained. However, when the difference between the thickness B1 of the elastic layer 15a and the thickness B of the elastic layer 16a exceeded ±3%, the image magnification error variation occurred. Thus, the image formed material usable as an output material was not obtained. The state in which no substantial image magnification error variation occurs includes a state in which a variation occurs to the extent that the variation does not affect the actual use of an output material.

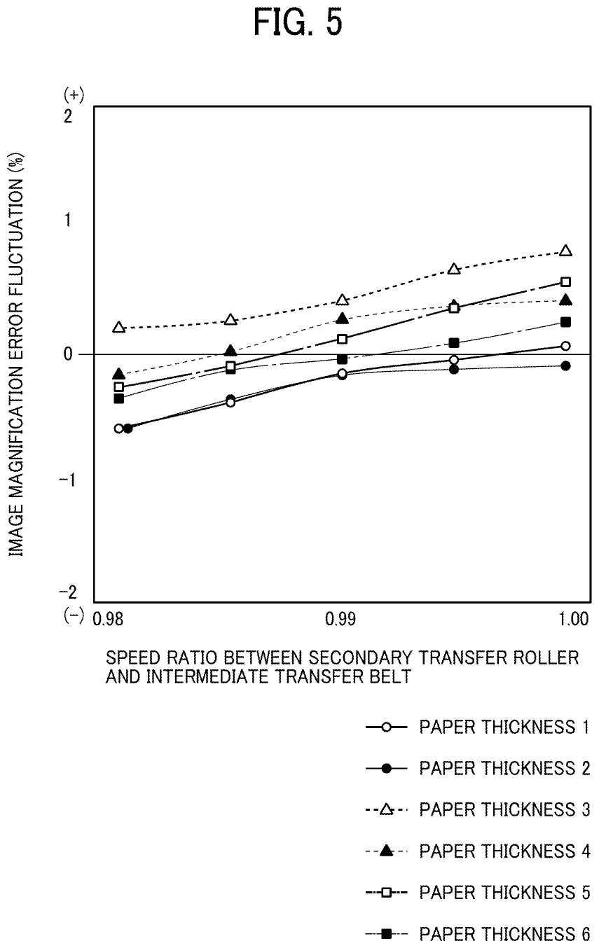

As described above, according to the secondary transfer unit 25 of the present embodiment, the difference between the thickness B1 of the elastic layer 15a of the secondary transfer roller 15 and the thickness B of the elastic layer 16a of the secondary transfer counter roller 16 is set to ±3% or less so that the amount of deformation of the elastic layer 15a and the amount of deformation of the elastic layer 16a are substantially equal to each other at the time of pressure contact. Thus, the nip portions of the secondary transfer roller 15 and the secondary transfer counter roller 16 at the secondary transfer portion N can be flattened. As a result, the length A of the upper surface and the length A1 of the lower surface of the transfer sheet S at the time of secondary transfer can be equal to each other. Thus, a transfer device and an image forming apparatus can be provided that can reduce the occurrence of image magnification error variation without generating a waste sheet. The preferable range of the difference between the thickness B1 of the elastic layer 15a and the thickness B of the elastic layer 16a depends on the difference in hardness between the elastic layer 15a and the elastic layer 16a. For example, when the elastic layers 15a and 16a have the same hardness, the smaller the difference between the thicknesses B1 and B, the more preferable. FIG. 5 is a graph illustrating the relationship between the rigidity (sheet thickness) of the transfer sheet S in the secondary transfer unit 25 and the image magnification error variation. As illustrated in FIG. 5, in the configuration of the present embodiment, the variation width of the range of occurrence of the image magnification error variation that occurs due to a difference in rigidity of the transfer sheet S is smaller on the plus side and the minus side. Thus, reducing (controlling) the image magnification error variation is easier than in the comparative configuration described above.

The inventors of the present disclosure have made a difference in hardness between the elastic layers 15a and 16a and have confirmed to what extent the difference in hardness affects the image magnification error variation. In the confirmation test, the elastic layers 15a and 16a having a hardness difference from each other were used, the difference between the thicknesses B1 and B was set to ±3% or less, image formation was performed. Thus, the image lengths of output materials on which the images were formed were measured, and the differences from the ideal image lengths on the data were obtained. The inventors of the present disclosure determined whether the image magnification error variation was reduced. As a result of the determination, reducing the occurrence of the image magnification error variation was confirmed when the difference in hardness between the elastic layers 15a and 16a is an Asker C hardness of 15 or less. However, when the difference in hardness between the elastic layers 15a and 16a exceeds an Asker C hardness of 15, the image magnification error variation rarely occurs. As a result, setting the difference in hardness between the elastic layers 15a and 16a to be an Asker C hardness of 15 or less can further reduce the occurrence of image magnification error variation.

As a result of the determination, the inventors of the present disclosure have confirmed that the surface of the intermediate transfer belt 7 made of an elastic body is easily crushed and the followability of the intermediate transfer belt 7 with respect to the surface of the transfer sheet S is improved when the hardness of the elastic layer 15a is higher than the hardness of the elastic layer 16a. As a result, transferability in a case of using uneven paper or rough paper which has been used more frequently in recent years can be enhanced. The inventors of the present disclosure performed image formation by changing the hardness of the intermediate transfer belt 7 and confirmed the influence of the hardness of the intermediate transfer belt 7 on the image formation. In the confirmation test, the inventors used belts having different hardnesses as the intermediate transfer belt 7. The hardness of each of the elastic layers 15a and 16a was set to an Asker C hardness of 75 or less, the difference between the thicknesses B1 and B was set to ±3% or less, and image formation was performed. Thus, the inventors checked the output materials on which images were formed. As a result of the confirmation, the inventors found that setting the hardness of the intermediate transfer belt 7 to a micro rubber hardness of 70 or less improved the followability of the intermediate transfer belt 7 with respect to the unevenness of the surface of the transfer sheet S. Thus, the inventors confirmed that the transferability in the case of using an uneven paper sheet or a rough paper sheet is further improved.

In the present embodiment, an example in which the printer 30 is described as an image forming apparatus, but the image forming apparatus is not limited thereto. The present disclosure is applicable to a copier, a facsimile machine, a multifunction peripheral (MFP), and color image forming apparatuses. In the present embodiment, the transfer sheet S is mentioned as an example of the recording medium on which an image is formed. However, the recording medium is not limited to a recording paper sheet but also includes thick paper, a postcard, an envelope, plain paper, thin paper, coated paper, art paper, tracing paper, an overhead projector transparency (OHP sheet or OHP film), a resin film, and any other sheet-shaped material on which an image can be formed.

Numerous additional modifications and variations are possible in light of the above teachings. It is therefore to be understood that, within the scope of the above teachings, the present disclosure may be practiced otherwise than as specifically described herein. With some embodiments having thus been described, it will be obvious that the same may be varied in many ways. Such variations are not to be regarded as a departure from the scope of the present disclosure and appended claims, and all such modifications are intended to be included within the scope of the present disclosure and appended claims.

1. A transfer device comprising:
a transfer roller having an elastic layer on an outer surface of the transfer roller, the transfer roller configured to contact with and separate from an image bearer including a belt-shaped elastic body to bear a toner image, the transfer roller configured to nip a recording medium between the image bearer and the transfer roller; and
a transfer counter roller having an elastic layer on an outer surface of the transfer counter roller, the transfer counter roller disposed facing the transfer roller via the image bearer, the transfer counter roller configured to nip the image bearer with the transfer roller,
wherein the transfer counter roller or the transfer roller is configured to be applied with a bias to transfer the toner image on the image bearer onto the recording medium,
wherein each of the elastic layer of the transfer roller and the elastic layer of the transfer counter roller has an Asker C hardness of 75 or less, and
wherein a difference in thickness between the elastic layer of the transfer roller and the elastic layer of the transfer counter roller is ±3% or less.

2. The transfer device according to claim 1,
wherein the difference in hardness between the elastic layer of the transfer roller and the elastic layer of the transfer counter roller is an Asker C hardness of 15 or less.

3. The transfer device according to claim 1,
wherein the elastic layer of the transfer roller is higher in hardness than the elastic layer of the transfer counter roller.

4. The transfer device according to claim 1,
wherein the image bearer has a micro rubber hardness of 70 or less.

5. An image forming apparatus comprising:
the transfer device according to claim 1; and
the image bearer,
wherein the image bearer is an intermediate transfer belt.
